(19) United States
(12) Patent Application Publication
(10) Pub. No.: US 2010/0200657 A1
(43) Pub. Date: Aug. 12, 2010

(54) DISPLAY FIXTURE BUILD AND MAPPING SYSTEM AND METHOD AND RELATED PRODUCT SALES INFORMATION SYSTEM AND METHOD

(75) Inventor: William E. Morgan, Guilford, IN (US)

Correspondence Address: THOMPSON HINE L.L.P.;Intellectual Property Group, P.O. BOX 8801, DAYTON, OH, 45401-8801, US

(73) Assignee: J&J PACKAGING CO., Sunman, IN (US)

(21) Appl. No.: 12/692,016

(22) Filed: Jan. 22, 2010

Related U.S. Application Data
(60) Provisional application No. 61/151,650, filed on Feb. 11, 2009.

(51) Int. Cl. G06K 15/00

(52) U.S. Cl. 235/383

(57) ABSTRACT

A method of building and mapping a product display, the method involves the steps of: (a) utilizing a product display unit having multiple product holding locations, each product holding location for receiving multiple products for display; (b) assigning a parent identification data to the product display unit; (c) for each product holding location, utilizing unique item identification data for at least one product loaded into the product holding location, and linking the unique item identification data to data identifying product type; and (d) storing each unique item identification data and its associated data identifying product type in association with the parent identification data and data identifying the product holding location into which the product is loaded to create a data map of the product display unit and products loaded into the product holding locations of the product display unit.

### CROSS-REFERENCES

This application claims the benefit of U.S. Provisional Application Ser, No. 61/151,650, filed Feb. 11, 2009, the entirety of which is incorporated herein by reference.

### TECHNICAL FIELD

The present invention relates generally to product displays utilized in the retail environment and, more particularly, to a promotional product display fixtures build and mapping system that facilitates product tracking.

### BACKGROUND

Product manufacturers continually evaluate how to increase product sales at retail locations (e.g., supermarkets, groceries, department stores, club stores, discount stores, convenience stores, mass merchants, home goods stores and specialty stores) in order to increase market share and/or revenue. It is generally known that one way to increase product sales is through the use of in-store promotional product display units that are configured and positioned to highlight products to customers in the store (e.g., end-cap type product display units or check-out line product display units). Often times product manufacturers actually pay retailers, or provide retailers with promotional pricing that will enable higher retailer profits, for placing such promotional product display units in the store. However, there is current no convenient technique for evaluating the effectiveness of such promotional product display units or for monitoring whether retailers are properly using or placing such promotional product display units.

It would be desirable to provide a method and system useful in connection with promotional product display units for tracking and evaluating product sales and better understanding the effectiveness of promotional product display units.

### SUMMARY

In one aspect, a method of building and mapping a product display, the method involves the steps of: (a) utilizing a product display unit having multiple product holding locations, each product holding location for receiving multiple products for display; (b) assigning a parent identification data to the product display unit; (c) for each product holding location, utilizing unique item identification data for at least one product loaded into the product holding location, and linking the unique item identification data to data identifying product type; and (d) storing each unique item identification data and its associated data identifying product type in association with the parent identification data and data identifying the product holding location into which the product is loaded to create a data map of the product display unit and products loaded into the product holding locations of the product display unit.

In another aspect, a pre-loaded product display for shipment to a retail location is provided and includes a product display unit having multiple product holding locations, the product display unit having assigned parent identification data, each product holding location having multiple items of product loaded therein, at least two items of product in each product holding location having respective unique item identification data thereon, where each unique item identification data is linked in a database to each of data identifying product type, data identifying the product holding location and the parent identification data to create a data map of the product display unit; and a shipping package in which the product display unit is loaded, the shipping package including identifying information thereon including the parent identification data of the product display unit and each unique item identification data associated with product loaded therein.

In a further aspect, a computerized system for tracking product sales from product display units that each have multiple product holding locations is provided. The system includes a database of product maps, each product map defined at least in part by: a parent identification data assigned to a single product display unit; multiple instances of unique item identification data, each unique item identification data linked with a single product package loaded into the single product display unit; each instance of unique item identification data linked to each of the parent identification data, data identifying product type for the single product package and data identifying the product holding location into which the single product package is loaded.

In yet another aspect, a method for selling product on a promotional basis at a retail store involves: (a) placing a product display unit at the retail store, the product display unit having multiple product holding locations, the product display unit having assigned parent identification data, each product holding location having multiple items of product loaded therein, multiple items of product in each product holding location having respective unique item identification data thereon, where each unique item identification data is linked in a database to each of data identifying product type, data identifying the product holding location and the parent identification data to create a data map of the product display unit; and (b) tracking product sales from the product display unit based upon scanning of the unique item identification data during product sale.

The inventive aspects may provide certain advantages over current systems and methods, such as attaining better display unit compliance (e.g., assuring that retailers give promotional product display units proper floor space); providing performance based goals and rewards to retailers based upon sales performance from product display units; providing insight into product sales that will enable improvement and more effective allocation of promotional display unit efforts; providing specific, detailed information on display unit performance; providing enhanced opportunities for timely and effective couponing, special offers and loyalty program incentives based upon sales of products from promotional product display units; and providing traceability for each item loaded into a product display unit, enabling fast corrective action should a product recall or change be necessary.

The details of one or more embodiments are set forth in the accompanying drawings and the description below. Other features, objects, and advantages will be apparent from the description and drawings, and from the claims.

### BRIEF DESCRIPTION OF DRAWINGS

FIG. 1 is a high level system diagram;

FIG. 2 represents a product display unit mapping operation;

FIG. 3 is a schematic representation of a line for product display unit build and mapping;

FIG. 4 is a system diagram relating to sales tracking and reporting;

FIG. 5 is an exemplary data table relating to product sales;

FIG. 6 is an exemplary data graph relating to product sales; and

FIG. 7 is another exemplary data graph relating to product sales.

### DETAILED DESCRIPTION

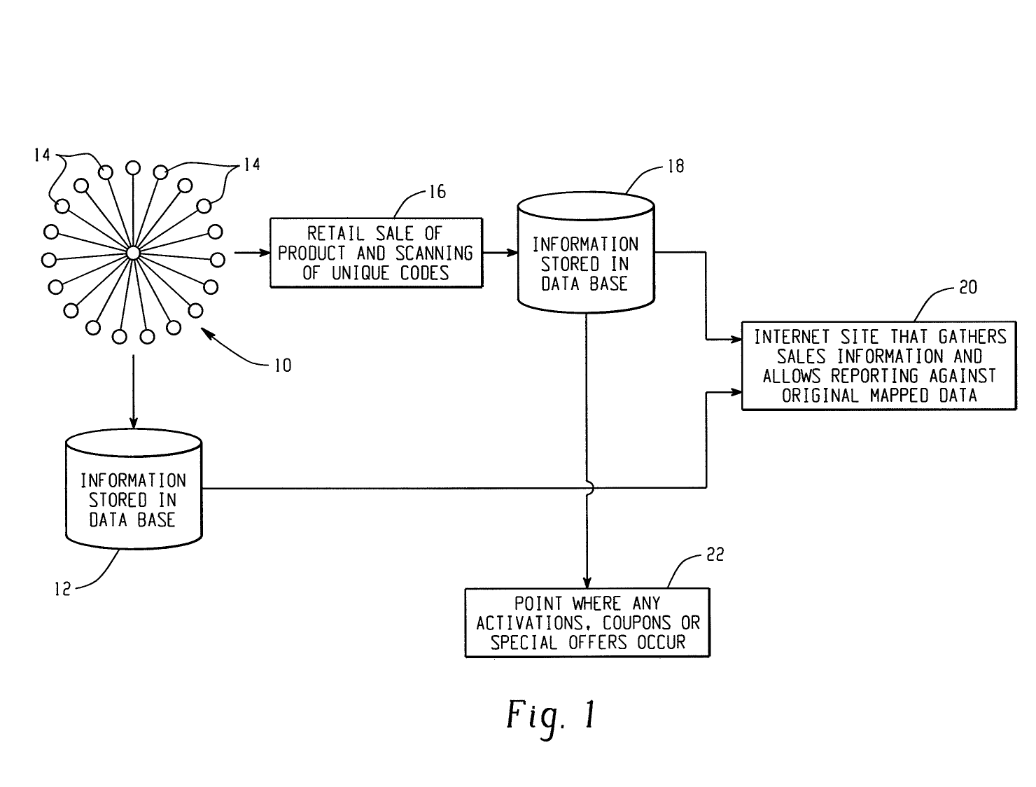

Referring to FIG. 1, a high level representation of a method and system for promotional product display units is shown. Generally, a step of building and mapping product display units into a database is shown by elements 10 and 12, where element 10 is a graphic representation of a product display unit having multiple product holding locations 14, and element 12 represents a computerized database of stored product maps for product display units. Product display units 10 are located at retail locations 16 where the products can be sold and unique codes associated the products loaded into the product holding locations of the product display units can be identified at the time of sale and stored in a database 18. A computerized system 20 for tracking and evaluating product sales from product display units 10 receives both the product map data and the product sales data so that sales from individual product display units can be examined and evaluated. A third party computer system 22 represents the location where various post-sale activities occur such as product activation (e.g., in the case of gift cards or calling cards) or generation of coupons or special offers tied to the product sales.

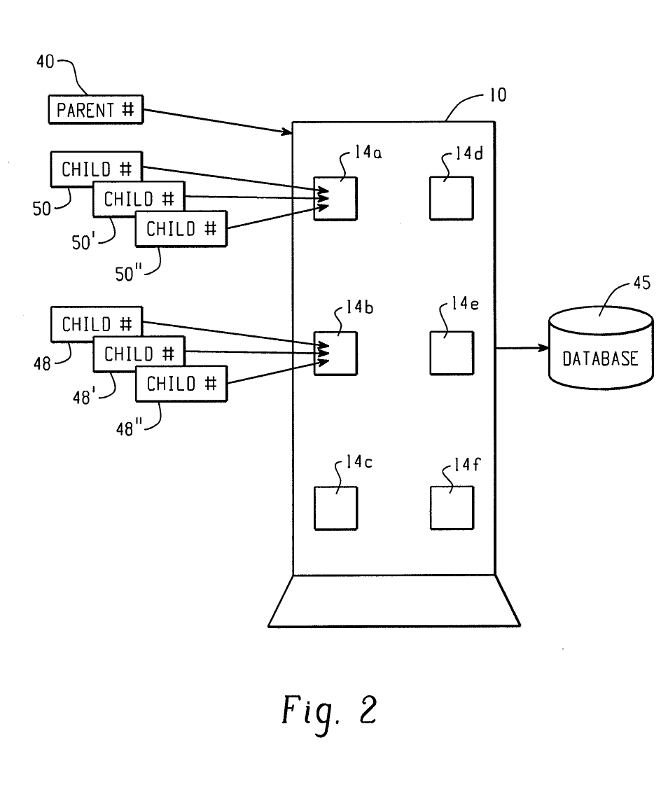

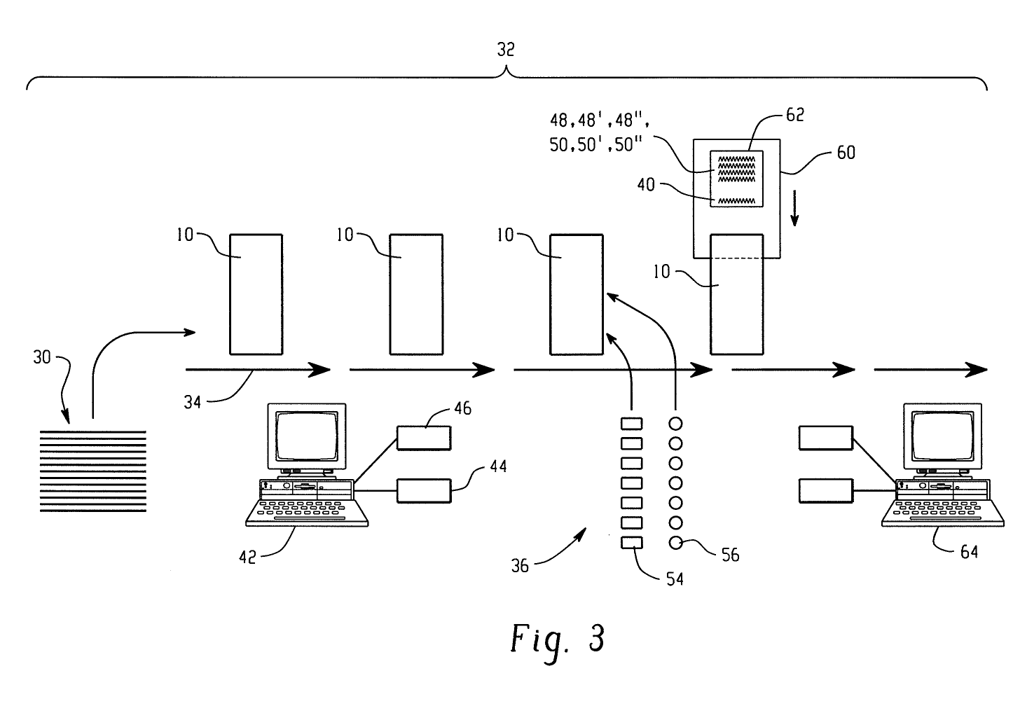

Turning now to FIGS. 2-3, an exemplary description of the product display unit and mapping operation is provided, where the build and map operation takes place at a manufacturing facility and once the build and map operation is completed the fully loaded product display unit is then shipped to a retail location for use. Specifically, a product display unit 10 having multiple product holding locations 14 is used, where each product holding location is typically configured for receiving multiple products for display. By way of example, the product display unit may be of paperboard, corrugated board or plastic component construction, but variations are possible. A supply 30 of unassembled product display units may be located at the start of a production line 32, and the units may be assembled and placed on a conveying line 34 (e.g., a rolling surface) and moved downstream toward one or more product loading locations 36.

A unique parent identification data 40 (e.g., an alphanumeric identifier) is assigned to each product display unit 10. A computer system 42 may be used to assign the parent identification data. For example, the computer system may enable the operator to select (e.g., using a graphical user interface) from a number of different product display unit types to be loaded with product, and one the operator selects the product display unit type, the computer automatically assigns the parent identification data 40 to the unit. The computer system 42 may include an associated label printer 44 and scanner 46 (e.g., bar code, RFID or magnetic stripe scanner). In this regard, if desired, when the computer system assigns the parent identification data 40 a label incorporating that data (e.g., showing the actual parent # and/or incorporating that parent # into a printed bar code, or incorporating the parent # into an RFID tag on the label) may be automatically printed and the operator may apply the label to the product display unit to be loaded (e.g., typically on the back or bottom of the unit). A database stores the parent identification data 40 in association with data identifying the type for the product display unit 10, including number of product holding locations 14a-14f (in this case six) and location of each specific product holding location (e.g., location 14a is first row-first column, location 14b is second row-first column, etc.).

Next, for each product holding location, unique item identification data (e.g., a child # represented by 48, 48′ and 48″ and 50, 50′ and 50″) is identified or assigned at least one product, and preferably all products, loaded into the product holding location, and linking the unique item identification data to data identifying product type.

In one example, where the product is a calling card or gift card, unique identification data may already be incorporated into the packaging of the product (e.g., a single gift card has an associated unique number (e.g., in the form of a bar code on the package) for activation purposes, or a multi-pack gift card package may have a unique number (e.g., in the form of a bar code on the package) for activation purposes, where the unique package number is linked to or incorporates each unique card #). In such examples, the unique item identification data may be scanned using the scanner 46.

In another example, for more traditional products (e.g., batteries or some other actual product) the product packaging may include a universal number that identifies the product but that does not distinguish one instance of the product from another (e.g., a common UPC bar code number is placed on all products of the same type). For example, all packages of 4 AAA batteries of the same brand and package type will include a common UPC bar code, while all packages of 8 AAA batteries of the same brand and package type will include a common UPC bar code that is different than that of 4 pack). In these latter instances, it will typically be necessary for the computer system to assign the unique identification data to each instance of product being loaded. This process may be achieved by first scanning the UPC of the product package, the computer system responds by assigning unique item identification data for that package and printing a label incorporating the unique item identification data (e.g., in the form of a bar code), which label the operator then applies directly to the package. In most instances the label is applied to the package such that the label bar code overlies the original package UPC bar code, and the unique item identification data is a unique alphanumeric sequence that is based upon and/or incorporated the retail UPC bar code number, but variations are possible.

Each unique item identification data, whether assigned or scanned, and its associated data identifying product type (e.g., the UPC number and/or SKU) is stored in the database 45 in association with the parent identification data 40 for the product display unit and data identifying the product holding location into which the product is loaded to create a data map of the product display unit and products loaded into the product holding locations of the product display unit. In this regard, the computer system 42 may provide the operator a graphical user interface that enables the operator to do an on-screen selection of which product holding location is being loaded during the process of scanning or assigning the unique item identification data to each product package. Typically, for a given product holding location multiple instances of the same product type are loaded into the product holding location.

For example, product type 52 may be loaded into one product holding location and product type 54 may be loaded into another product holding location. In this regard, a single loading station with a single computer system 42 may be used to load the multiple product types or, alternatively, additional computer systems may be provided, one for each type of product to be loaded. Moreover, although the above description focuses on operator involvement in the product loading process, it is recognized that fully automated systems could be developed.

Once a product display unit is fully loaded with product that has been mapped, the unit can be placed within a shipping package 60 for shipping to a retail location. In this regard, the shipping package includes identifying information thereon including the parent identification data 40 of the product display unit and each unique item identification data 48, 50 associated with product loaded in the product display unit. For example, this information may be printed on a label 62 by a downstream computer system 64. The parent data and unique item identification data may be printed in alphanumeric form and/or bar code form. Moreover, the shipping package 60 may include identifying information thereon designating a retail location and specific department or location within the retail location where the product display should be placed. In such instances, this additional information may be linked with the data map in the database for tracking purposes.

With respect to the data maps that are produced for product display units, it is preferred, though not required, that the data map include a graphical image showing the general configuration of the product display unit and the product holding locations on the product display unit (e.g., per the representation shown in FIG. 2). When a product map is retrieved from the database the database program may permit a user to, for example, select each of the product holding locations so that the unique item identification data for products in the selected product holding location are shown on the computer screen along with general information regarding the product. By way of example only, the following data, shown in hierarchical arrangement, may be incorporated into a product data map, where the exemplary product display unit includes only three product holding locations and each location holds only two products, for simplicity.

Exemplary Product Display Unit Data Map

```
Parent #
    Retail Store Data
        Store Department
    Display Unit Type Data
    Graphical Image Data
    Manufacturer Data
    Product Holding Location 1
        Location Data (i.e., location on the display unit)
        Unique Item #
            Associated UPC # and data
        Unique Item #
            Associated UPC # and data
    Product Holding Location 2
        Location Data (i.e., location on the display unit)
        Unique Item #
            Associated UPC # and data
        Unique Item #
            Associated UPC # and data
    Product Holding Location 3
        Location Data (i.e., location on the display unit)
        Unique Item #
            Associated UPC # and data
        Unique Item #
            Associated UPC # and data
```

Although the above product build and map process is described with reference to the build and map operation taking place in a manufacturing facility, it is recognized that variations are possible. For example, for a product display unit build at the actual retail location, a portable computer system with scanner and label printer may be provided. Alternatively, a set or kit of labels including a label with parent identification data and multiple labels including unique item identification data may be printed at a first location and shipped as a build kit to the retail location for application to product as it is loaded into the product display unit. Where the final configuration for the loaded product display unit is pre-established (i.e., specific product types and number of each to be loaded into the product display unit), it may not be necessary to use any computer system or scanning for the actual build, as the product map may be pre-established as well, and the kit provided with instructions for which labels are to be applied to which products for given product holding locations. While there is some reliance on build personnel competency in such an implementation, satisfactory results could be achieved. The build kit could also be shipped to a secondary build location (e.g., another product display unit manufacturer location) and the fully loaded product display unit shipped to the retail location. The build kits could also include pre-printed labels to be applied to the shipping package for each product display unit. In this arrangement, one party may act as the master for creation and storage of product display unit data maps, while multiple different parties actually build the product display units.

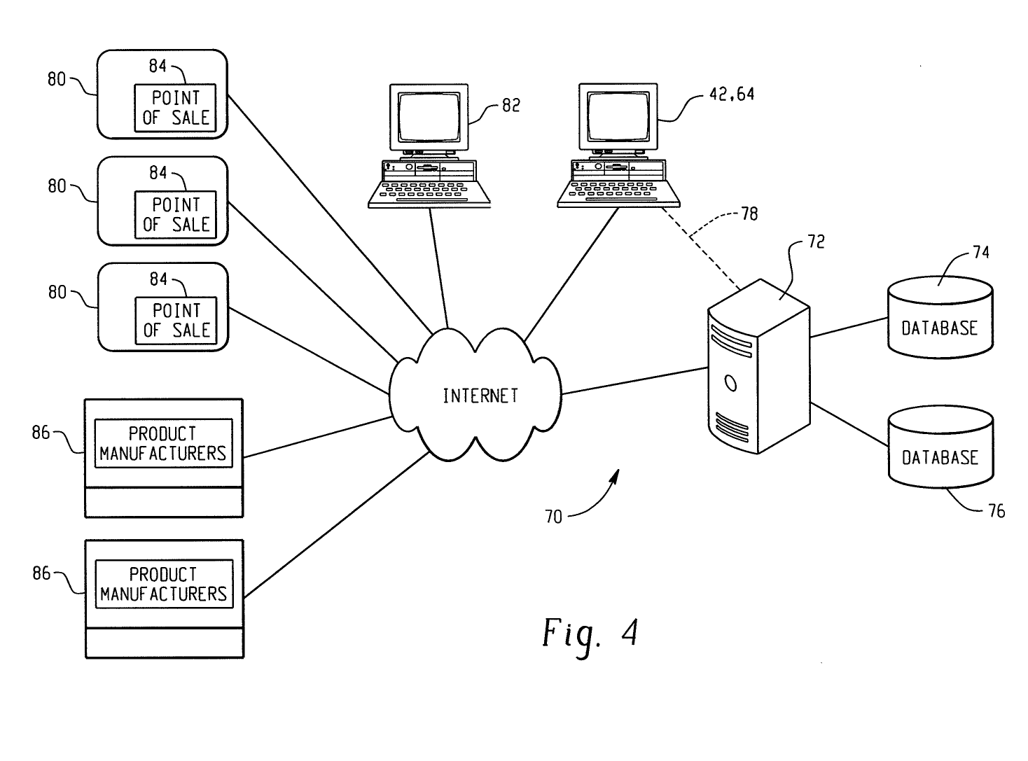

Referring now to FIG. 4, a computerized system 70 for tracking product sales from mapped product display units is shown. The system 70 includes, for example, a server 72 and associated databases 74, 76. The databases store product display unit data maps in accordance with those described above. This information may be provided to computer system 70 via a direct communications link 78 with the computer systems 42, 64 used to create the data maps, or via an Internet based link. The unique item identification data related information needed for retailers to process item sales, can also be provided, by any one of the computer systems 42, 64, 70 directly to retailer computer systems 80 and/or to one or more third party computer systems 82 that are accessed by retailers. Retailer point-of-sale systems may provide sales data regarding items from product display units directly to the computer system 70 and/or to the third party system 82. The sales data is then maintained by computer system 70 for subsequent access by product manufacturers 86 that make use of the mapped product display units. In this regard, each manufacturer may be assigned unique login information, and the server 72 presents a login page for manufacturers. Once logged in, the manufacturer's access to data is limited to product display units for its own products.

The retailers may also communicate data to the computer system 70 regarding date of receipt of the product display unit in the back room, date of placement of the product display unit on the retail floor and date of removal of the product display unit from the retail floor, all of which may be indicated by scanning operations that take place at each step.

Certain types of sales data may actually be initially collected by the manufacturer and then communicated by the manufacturer to the computer system 70 (e.g., in the case of prepaid and gift cards).

When items of product from a mapped product display unit are sold at retail, the point-of-sale system identifies the product by its unique item identification data (e.g., by scanning the unique item identification data bar code or RFID tag) and a record of the date, time and location of the sale is subsequently communicated to the computer system 70. The computer system 70 includes product map update code that identifies the product data map associated with the unique item identification data and updates the product data map to reflect the sale, thus indicating that the sold item is no longer loaded onto the product display unit. In this manner, an accurate and up-to-date product map for each product display unit can be maintained.

The computer system 70 also includes product sales tracking code that enables users (e.g., product manufacturers 86 interested in sales data for their products) to readily evaluate sales activity and trends from any number of different perspectives. For example, the product sales tracking code may have the capability to generate sales data in any one of the following formats: total sales from a given product display unit, either within a set time frame or cumulative; total sales from product display units at a given retail location; sales from individual product display units that are all located at a same retail location; sales based upon product type; comparative sales of different product types from a common type of product display unit; total sales from a specific retail chain or retail store type; total sales for a common type of product display unit; sales by product location for a common type of product display unit; and comparative sales by store department placement for a common type of product display unit.

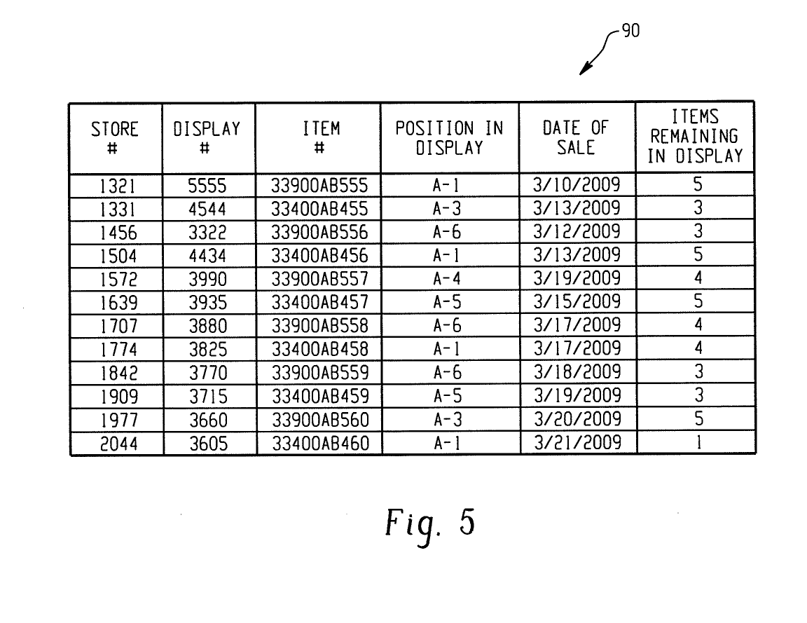

By way of example, FIG. 5 shows a simple table format that may be provided to a manufacturer providing basic sales data for product display units holding product associated with that manufacturer, where retail store #, display # (i.e., the parent identification data), item # (i.e. the unique item identification data), display position, date of sale and items remaining in the product display unit are show.

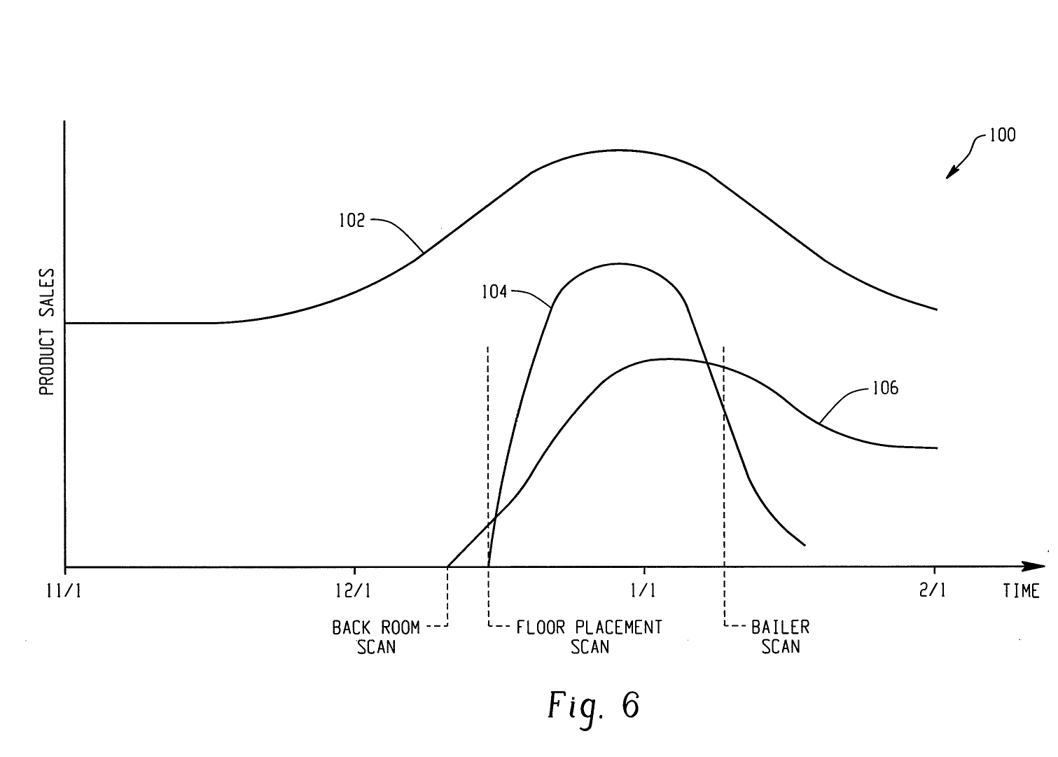

FIG. 6 shows an exemplary graphical data display 100 that may be provided, where curve 102 represents a historical sales curve for product over time from a standard shelf display within a store, curve 104 represents an actual sales curve from one product display unit within the store and curve 106 represents an actual sales curve from another product display unit within the store. By comparing the curves, an analysis can be made of whether a product display unit was properly placed and utilized by the store. For example, curve 104 may indicate proper use and placement of its product display unit based upon the spike in product sales that does not fit the curve 102, while curve 106 may indicate improper use or placement of its product display unit based upon the fact that sales of product occurred before the product display unit was placed on the floor and by the fact that the curve matches closely to the expected, historical curve for product that is not on a promotional product display unit.

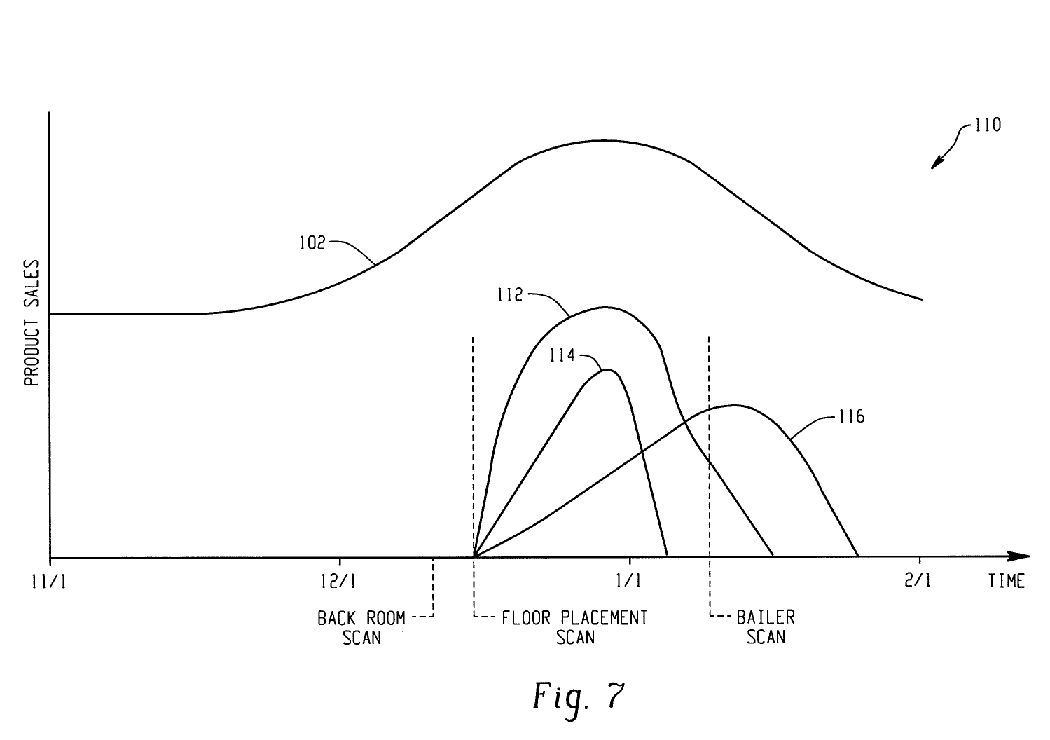

FIG. 7 shows another exemplary graphical data display 110 that may be provided, where curves 112, 114 and 116 represent actual sales data curves for different product types located on the same product display unit (e.g., either for a single product display unit or collectively for multiple product display units of the same type that were loaded in a like manner). Ana analysis of this data may show, for example, that too many of the product type associated with curve 116 were loaded on the display unit(s) and too few of the product type associated with curve 114 were loaded on the display unit, enabling a product manufacturer to better target the display unit configuration for future implementations.

The computer system 70 may be more automated as well. For example, where each product map is identified with a specific product manufacturer, upon the occurrence of a specified event relating to sales of product associated with a given product map, the product sales tracking code may be configured to send an electronic message to the specific product manufacturer identified with the product map. Where the specified event identifies that one or more products loaded into the product display unit associated with the given product map have been exhausted, the specific product manufacturer is alerted to a need to reload the product display. Where the specified event identifies that product sales for products loaded into the product display unit associated with the given product map reflect that the product display unit likely has not been properly located, the specific product manufacturer may be notified of the potential problem so that an on-site inspection can me made. Other types of events and messages could be implemented.

The product sales tracking code may be configured to evaluate product mix for a given type of product display unit based upon actual product sales data from the given type of product display unit, including automatically identifying at least one of (i) a product type that is overstocked on the given type of product display unit or (ii) a product type that is overstocked on the given type of product display unit. The product sales tracking code may be configured to provide comparative sales data for (i) sales of a given product type from product display units and (ii) sales of the given product type from standard store shelf display.

The additional data made available through the inventive mapping and sales tracking may facilitate alternative arrangements between manufacturers and retailers. For example, a method for selling product on a promotional basis at a retail store involves:(a) placing a product display unit at the retail store, the product display unit having multiple product holding locations, the product display unit having assigned parent identification data, each product holding location having multiple items of product loaded therein, multiple items of product in each product holding location having respective unique item identification data thereon, where each unique item identification data is linked in a database to each of data identifying product type, data identifying the product holding location and the parent identification data to create a data map of the product display unit; and (b) tracking product sales from the product display unit based upon scanning of the unique item identification data during product sale.

Tracked product sales data for the product display unit may be compared to specific sales performance data; and based upon the comparison, a promotional payment amount to be made to the retail store may be established. The promotional payment amount may be an actual monetary transfer amount from the manufacturer to the retailer or may be a discount amount to be applied to purchase made by the retailer from the manufacturer. By way of example, the specific sales performance data may be historical sales performance data for products loaded into product display units that are of the same type as the product display unit.

In another example, the specific sales performance data may be multiple sales target levels, each sales target level having an associated set promotional payment amount. A sales target level achieved for the product display unit is identified, and the promotional payment amount is established to be the set promotional payment amount associated with the achieved sales target level.

A location of the retail store of the product display unit is typically identified. Upon occurrence of a specified event relating to product sales for the location, a price change may be implemented for products of the product display unit through use of each unique item identification data associated with the product display unit. In one example, the specified event may be the occurrence or nonoccurrence of a weather event (e.g., a storm), and the price change is implemented by transmitting updated price information to the retail store. However, other types of events could be established for use in identifying and implementing coupon or loyalty program incentive opportunities at retailers.

Another example of an advantageous feature/method that can be implemented, either fully automated by computer or partially automated, is the determination of the best location within a store for a given product display type. By marking the outer label of each display unit according to what department it is to be located, and including that information in the data map, manufacturers would be able to compare sales from exactly the same display type, placed in two different locations within a store.

Product mix for a product display unit can also be analyzed as suggested above. The items as are mapped as they are loaded onto the display, and a designation is included in the data map that makes a distinction of one product versus another. The sale of one product versus another on the same display can be compared. Manufacturers will quickly be able to identify if they are selling out of an item on the display unit or if they are overstocked of another. In other words, if 10 packs of AA batteries are placed on the display unit and 20 packs of D cells are placed on the same display unit, and the product sales tracking code the display sold 2 packs of D cells and 5 packs of AA in the first week, a manufacturer conclude not enough AA and too many D cells for the promotional display unit were provided. A manufacturer can decide to either re-stock the existing display unit, given its known location, or can make decisions for future displays that are a better product mix.

The ability to test display sales of multiple types of products that are also sold from existing shelf locations within the same store is also provided. In the past, the shelf sales of the items have a standard bar code for each SKU and typically a display unit uses the same bar code and SKU. In such cases there was no way of telling one from the other; so you can not tell how the display did versus shelf product. Using the above product mapping technology and unique item identification data, manufacturers can use existing stock of product for promotional displays, send it to the display unit manufacturer, where the display unit manufacturer re-labels over the standard product bar code. Subsequent sales of products can then be distinguished as between standard shelf sales and promotion product display unit sales, enabling comparative sales analysis.

In terms of unique identification data and bar codes that are applied to items, two types of bar code applications may, by way of example be used. First, all bar code information—the SKU and the unique identifying information can be written into a new bar code. This allows the retailer to make one scan of one bar code and receive the necessary info to make the sale and record the product origin. The second method uses two bar codes, one for the standard SKU information, and a second for reading the origin information or any type of activation needs—such as couponing or special offers.

It is to be clearly understood that the above description is intended by way of illustration and example only, is not intended to be taken by way of limitation, and that other changes and modifications are possible.

For example, while it is contemplated and desired that each mapped product display unit be shipped to a predefined, known location that is incorporated into the data map, it is recognized that mapped product display units could be produced in bulk and shipped to various retail locations with a predefined relationship of which unit is shipped to which retail location. In such an embodiment, the install location of each mapped product display unit could be determined by a subsequent scanning operation at the retail location (e.g., a back room scan of the parent identification data on the shipping package or a P.O.S. scan of the unique identification data for the first product sold from the installed product display unit) and the scanned information could be communicated back to the computer system 70, which would then incorporate the retail location information into the data map for the received parent identification data or for the data map associated with the received unique identification data.

Moreover, while the primary discussion above refers to the use of bar codes to apply parent identification data to product display units and unique item identification data to packages loaded into product display units, it is recognized that other technologies could be used, such as RFID tags, magnetic swipe bars, smart chips or others.

What is claimed is:

1. A method of building and mapping a product display, the method comprising the steps of:
(a) utilizing a product display unit having multiple product holding locations, each product holding location for receiving multiple products for display;
(b) assigning a parent identification data to the product display unit;
(c) for each product holding location, utilizing unique item identification data for at least one product loaded into the product holding location, and linking the unique item identification data to data identifying product type; and
(d) storing each unique item identification data and its associated data identifying product type in association with the parent identification data and data identifying the product holding location into which the product is loaded to create a data map of the product display unit and products loaded into the product holding locations of the product display unit.

2. The method of claim 1 wherein each unique item identification data is pre-established on packaging of the product and is read using a scanning mechanism.

3. The method of claim 1 wherein each unique item identification data is established via a computer and printed on a corresponding label that is applied to packaging of the product before loading of the product into the product holding location.

4. The method of claim 3 wherein each unique item identification data is printed in the form of a bar code on its corresponding label and each corresponding label is applied over an existing bar code on packaging of the product.

5. The method of claim 3 wherein the labels are printed and applied at a manufacturing facility, once the product display unit is fully loaded with product it is shipped to a retail location for use.

6. The method of claim 5 wherein once the product display unit is fully loaded with product it is placed in a shipping package, and information is applied to the shipping package, the information including the parent identification data of the product display unit and each unique item identification data associated with product loaded therein.

7. The method of claim 5 wherein the retail location to which the product display unit is being shipped is stored in association with the data map of the product display unit for tracking purposes.

8. The method of claim 3 where the labels are printed and linked with the parent identification data at a first location, shipped in the form of a kit to a second location at which the product display unit is to be loaded with product, and the labels are applied to product packaging at the second location.

9. The method of claim 8 wherein the second location is one of:
(i) a product display manufacture and build location, once the product display unit is fully loaded with product it is shipped from the second location to a retail location for use, or
(ii) a retail location and product is loaded onto the product display unit at the retail location.

10. The method of claim 1 wherein in step (c) for each product holding location, the identifying and linking steps are performed for multiple products loaded into the product holding location.

11. The method of claim 1 wherein in step (c) for each product holding location, the identifying and linking steps are performed for all products loaded into the product holding location.

12. A pre-loaded product display for shipment to a retail location, comprising:
a product display unit having multiple product holding locations, the product display unit having assigned parent identification data, each product holding location having multiple items of product loaded therein, at least two items of product in each product holding location having respective unique item identification data thereon, where each unique item identification data is linked in a database to each of data identifying product type, data identifying the product holding location and the parent identification data to create a data map of the product display unit; and
a shipping package in which the product display unit is loaded, the shipping package including identifying information thereon including the parent identification data of the product display unit and each unique item identification data associated with product loaded therein.

13. The pre-loaded product display of claim 12 wherein each unique item identification data is in the form of one of a scannable bar code, a readable magnetic stripe or a detectable RFID code.

14. The pre-loaded product display of claim 12 wherein the shipping package includes identifying information thereon designating a specific department or location within the retail location where the product display should be placed, and wherein the specific department of location is linked with the data map in the database for tracking purposes.

15. A computerized system for tracking product sales from product display units that each have multiple product holding locations, the system comprising:
a database of product maps, each product map defined at least in part by:
a parent identification data assigned to a single product display unit;
multiple instances of unique item identification data, each unique item identification data linked with a single product package loaded into the single product display unit;
each instance of unique item identification data linked to each of the parent identification data, data identifying product type for the single product package and data identifying the product holding location into which the single product package is loaded.

16. The system of claim 15, further comprising:
a communications interface for receiving electronic data indicative of product having been sold, the electronic data including the unique item identification data associated with the product that was sold;
product map update code for identifying the product data map associated with the unique item identification data and updating the product map to reflect that the product is no longer loaded on the single product display unit associated with the product map.

17. The system of claim 15, further comprising:
a communications interface for receiving electronic data indicative of products having been sold, the electronic data including the unique item identification data associated with products that were sold and respective dates of sale;
product sales tracking code for tracking product sales from each product display unit based upon receipt of the electronic data indicative of products having been sold.

18. The system of claim 17 wherein the product sales tracking code is configured to generate sales reporting data in multiple formats, including at least one or more of:
total sales from a given product display unit, either within a set time frame or cumulative;
total sales from product display units at a given retail location;
sales from individual product display units that are all located at a same retail location;
sales based upon product type;
comparative sales of different product types from a common type of product display unit;
total sales from a specific retail chain or retail store type;
total sales for a common type of product display unit;
sales by product location for a common type of product display unit; or
comparative sales by store department placement for a common type of product display unit.

19. The system of claim 17 wherein each product map is identified with a single product manufacturer, the system further comprising:
a server for providing product manufacturers Internet-based access to product sales data, the server configured to:
permit login of a product manufacturer utilizing distinct manufacturer identification data;
based upon the distinct manufacturer identification data, limit access to product sales data only to product sales data associated with product maps identified with the product manufacturer.

20. The system of claim 17 wherein each product map is identified with a specific product manufacturer, upon the occurrence of a specified event relating to sales of product associated with a given product map, the product sales tracking code is configured to send an electronic message to the specific product manufacturer identified with the product map.

21. The system of claim 20 wherein the specified event identifies that one or more products loaded into the product display unit associated with the given product map have been exhausted so that the specific product manufacturer is alerted to a need to reload the product display.

22. The system of claim 20 wherein the specified event identifies that product sales for products loaded into the product display unit associated with the given product map reflect that the product display unit likely has not been properly located.

23. The system of claim 17 wherein the product sales tracking code is configured to evaluate product mix for a given type of product display unit based upon actual product sales from the given type of product display unit, including automatically identifying at least one of (i) a product type that is overstocked on the given type of product display unit or (ii) a product type that is overstocked on the given type of product display unit.

24. The system of claim 17 wherein the product sales tracking code is configured to provide comparative sales data for (i) sales of a given product type from product display units and (ii) sales of the given product type from standard store shelf display.

25. A method for selling product on a promotional basis at a retail store, the method comprising:
(a) placing a product display unit at the retail store, the product display unit having multiple product holding locations, the product display unit having assigned parent identification data, each product holding location having multiple items of product loaded therein, multiple items of product in each product holding location having respective unique item identification data thereon, where each unique item identification data is linked in a database to each of data identifying product type, data identifying the product holding location and the parent identification data to create a data map of the product display unit;
(b) tracking product sales from the product display unit based upon scanning of the unique item identification data during product sale.

26. The method of claim 25, further comprising:
(c) comparing tracked product sales data for the product display unit to specific sales performance data; and
(d) based upon the comparison made in step (c), establishing a promotional payment amount to be made to the retail store.

27. The method of claim 26 wherein the specific sales performance data comprises historical sales performance data for products loaded into product display units that are of the same type as the product display unit.

28. The method of claim 26 wherein the specific sales performance data comprises multiple sales target levels, each sales target level having a set promotional payment amount associated therewith, in step (c) a sales target level achieved for the product display unit is identified, in step (d) the promotional payment amount is established to be the set promotional payment amount associated with the achieved sales target level.

29. The method of claim 25, further comprising:
identifying a location of the retail store;
upon occurrence of a specified event relating to product sales for the location, implementing a price change for products of the product display unit through use of each unique item identification data associated with the product display unit.

30. The method of claim 29 wherein the specified event is occurrence or nonoccurrence of a weather event, and the price change is implemented by transmitting updated price information to the retail store.
